(19) United States
(12) Patent Application Publication
(10) Pub. No.: US 2010/0206177 A1
(43) Pub. Date: Aug. 19, 2010

(54) ASSEMBLY COMPRISING AN APPLIANCE AND A DISPOSABLE CAPSULE FOR PRODUCING A BREWED DRINK, AND CAPSULE FOR SUCH AN ASSEMBLY

(75) Inventor: Maddalena Ricotti, Casteggio (Pavia) (IT)

Correspondence Address: YOUNG & THOMPSON, 209 Madison Street, Suite 500, Alexandria, VA, 22314, US

(73) Assignee: SAMAR TECHNOLOGIES LTD., Neapoli, Limassol (CY)

(21) Appl. No.: 12/445,874

(22) PCT Filed: Oct. 3, 2007
(86) PCT No.: PCT/EP07/60498

§ 371 Date: Apr. 16, 2009

(30) Foreign Application Priority Data
Oct. 17, 2006 (IT) MI2006A001989

(51) Int. Cl. A47J 31/40

(52) U.S. Cl. 99/295

(57) ABSTRACT

The invention provides an appliance (1) and at least one disposable capsule (C1), the appliance including: —a brewing chamber (2) suitable for receiving a capsule and a closing pressure plate (3) that is movable axially (4) and is suitable for moving the capsule axially relative to the brewing chamber (2) during its axial movement in which it closes the brewing chamber (2); —polarizing means for the forced unambiguous positioning of the capsule (C1) within the brewing chamber (2); —a first hydraulic drink outflow path (10) suitable to be connected to a first orifice of the capsule (C1), through the brewing chamber; and—a second hydraulic drink outflow path (11), hydraulically separate from the first hydraulic path (10), which is suitable to be connected to a second orifice of the capsule, through the brewing chamber.

### FIELD OF THE INVENTION

The present invention relates to an assembly comprising an appliance for producing an aromatic brewed drink from a disposable capsule, and at least one associated capsule.

### BACKGROUND OF THE INVENTION

Automatic or semi-automatic so-called “coffee” machines are available on the market which comprise a brewing assembly comprising a brewing chamber, suitable for accommodating the capsule, and a pressure plate for hermetically sealing the brewing chamber, which exhibit relative movement between an open position and a closed position of the brewing chamber.

The brewing unit must have a precise, secure and reliable closure, primarily in order to ensure resistance to the hydraulic pressure when the brewing unit is operating at pressure, because the production of so-called “espresso” coffee by this type of appliance requires a pressure of about 9 bar.

The kinematics of the actuation of the brewing unit necessarily require a complicated structure and complicated functioning for the hermetic and reliable closure of the brewing chamber, while allowing the capsule to be placed in the brewing chamber and removed from the chamber and from the brewing unit after the corresponding serving of drink has been produced.

Also, existing coffee appliances or machines offer limited flexibility of use because they are not suitable for producing drinks of other types, other than coffee, except with poorer quality, which is largely due to the fact that some of the pipes become polluted or contaminated from one drink to another.

This is due to the fact that, for example, coffee machines nowadays usually have a single drink flow line leaving the brewing chamber. Therefore, drinks that are extremely different in their nature, composition, aromas, etc., travel along this single line with the risk that one drink will be contaminated by the residues of the drink produced during the preceding operating cycle of the machine. This happens if for example tea is produced after coffee, since the drink flow line or pipe leading out of the brewing chamber is the same for the coffee, then for the tea.

This invention provides a brewing assembly for a machine for brewing drinks, especially coffee, which eliminates the technical drawbacks inherent in the prior art, particularly to avoid the contamination problems described above and allow drinks of very different types to be made in succession while maintaining high standards of performance, and providing drinks with optimal organoleptic properties.

### SUMMARY OF THE INVENTION

To this end, the invention provides an assembly as claimed in claim 1.

Other features are defined in the secondary claims.

The invention also provides a capsule suitable to be accommodated in the appliance of such an assembly according to the invention.

### BRIEF DESCRIPTION OF THE DRAWINGS

Other aspects and features of the present invention will become apparent on reading the description of a preferred but not exclusive embodiment of the brewing appliance according to the invention, which is illustrated by way of non-restrictive example in the appended drawings, in which:

FIG. 1 is a view, in axial section at 1-1 as marked in FIG. 2, of the brewing unit (without the control lever) according to the present invention, which is illustrated in the rear retracted axial position of the pressure plate, corresponding to the open position of the brewing chamber;

FIG. 2 is a top plan view of the same brewing unit as in FIG. 1;

FIG. 3 is a perspective view of the same brewing unit as in FIG. 1, illustrated with the control lever;

FIG. 4 is a side view of the brewing unit of the appliance according to the invention shown in the forward axial position of the pressure plate, corresponding to the hermetically closed position of the brewing chamber;

FIG. 5 is a transverse section through the brewing unit at 5-5 as marked in FIG. 1;

FIG. 6 is an enlarged view of a detail of the capsule retention means, marked by a circle in FIG. 2;

FIG. 7 is a three-quarter rear perspective view of a first type of capsule according to the invention suitable to be accommodated in the brewing chamber;

FIG. 8 is schematic perspective view illustrating the internal layout of the brewing chamber according to the invention;

FIG. 9A is a rear view of the forward transverse end walls of the capsule shown in FIG. 7;

FIG. 9B is a schematic view, in axial section, showing the same capsule as FIGS. 7 and 9A in position in the brewing chamber;

FIGS. 10A and 10B are views similar to FIGS. 9A and 9B illustrating a second type of capsule according to the invention suitable to be accommodated in the brewing chamber; and

FIGS. 11A and 11B are views similar to those of FIGS. 9A and 9B showing a third type of capsule according to the invention suitable to be accommodated in the brewing chamber.

### DETAILED DESCRIPTION OF THE FIGURES

In the following description, identical, analogous or similar parts will be denoted by the same reference numbers.

Without implying any limitation, the terms vertical, longitudinal and transverse will be used with reference to the L, V, T reference system indicated in the figures, where the transverse T and longitudinal L axes are in the horizontal plane.

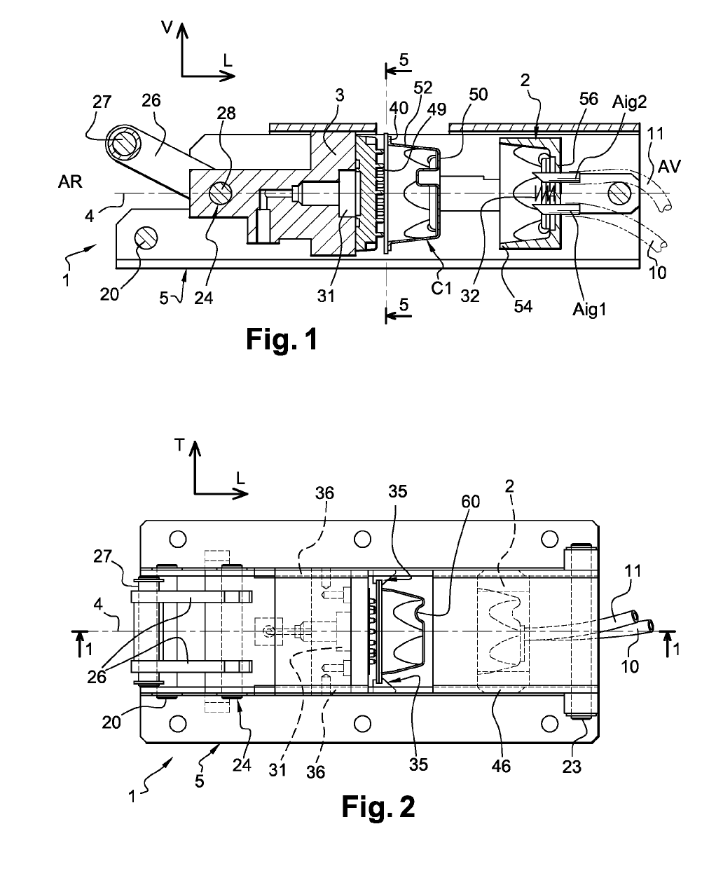

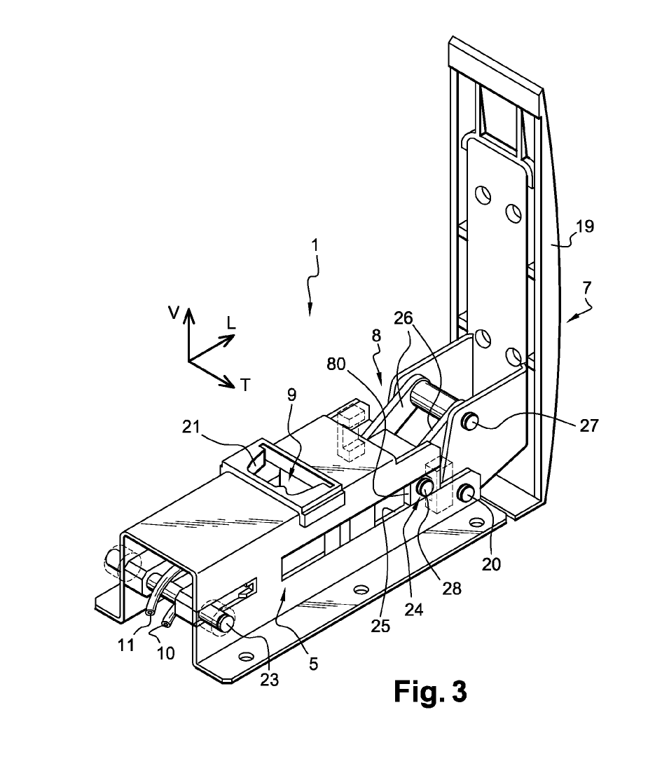

Referring to FIGS. 1-6, these show a brewing appliance for a coffee appliance or machine bearing the general reference 1.

The brewing appliance 1 comprises a brewing unit consisting of two complementary main components, namely a brewing chamber 2 and a pressure plate 3 for closing the brewing chamber 2.

The brewing chamber 2 is intended to accommodate and house a capsule Ci (C1, C2 or C3) which, as illustrated in the figures, is preferably a capsule containing the variety of coffee and/or any other aromatic essential oil intended for brewing.

The brewing chamber 2 and the closing pressure plate 3 are arranged coaxially on an axis 4 of translation (from front AV to rear AR), along which they are held in a relative position between an “open” position and a “closed position” of the brewing chamber 2.

The appliance 1 also has a main housing or frame 5.

In the particular case of the example illustrated and described, the closing pressure plate 3 is movable relative to the housing 5, while the brewing chamber 2 is fixed, being connected rigidly to the housing 5 which acts as a support and guide for the two main components of the brewing unit.

The housing 5, which in general shape is a rectangular parallelepiped, extends horizontally in a longitudinal direction parallel to the longitudinal axis 4 of translation of the movable pressure plate 3 relative to the fixed brewing chamber 2.

As a variant (not illustrated), it is also conceivable for the closing pressure plate 3 to be fixed and the brewing chamber 2 movable, or for both to be movable together relative to the housing 5.

The brewing appliance 1 comprises rotary means (that is, pivoting in both directions) 7 for controlling the brewing unit, and comprises means 8 of kinematic transformation which act to convert the rotation of the control means 7 into a relative longitudinal movement between the closing pressure plate 3 and the brewing chamber 2, along the axis of translation 4.

The brewing appliance 1 comprises other means 9 for the so-called “obligatory” positioning of the capsule Ci in the brewing chamber 2.

More precisely the purpose is to ensure that, once placed in the brewing unit, in a manner which will be described in more detail later, a capsule Ci will stay in a predetermined position with respect to the brewing chamber 2 into which it will then be placed, and more particularly in this case a constant angular orientation of the capsule about its main axis which, when the capsule is in the inserted position in the (brewing) unit, is an axis parallel to the axis of translation 4.

In the invention, the brewing chamber 2 has a first and at least one second separate flow paths V1 and V2, while the closing pressure plate has a path 31 for the introduction of hot water into a capsule for brewing purposes.

Each flow path V1 or V2 is connected permanently to the interior of the brewing chamber 2 and is suitable for allowing all or some of the prepared drink, depending on the type of capsule Ci used, to flow out.

This text will therefore refer to capsules of a first type, C1, for preparing a drink (e.g. coffee) which flows out of the capsule C1 and out of the brewing chamber 2 via hydraulic path V1, and only via the latter.

The text will also refer to capsules of a second type, C2, for preparing a drink of another type (e.g. tea or milk) which flows out of the capsule C2 and out of the brewing chamber 2 via hydraulic path V2, and only via the latter.

One variant will also have capsules of a third type, C3, for preparing a drink which flows out of the capsule C3 and out of the brewing chamber 2 via both hydraulic paths V1 and V2, in which case each path can be involved in supplying a single drink prepared from a single essential oil contained in the capsule C3, or supply, simultaneously or one being delayed after the other, two different liquid components necessary for preparing one drink from two different essential oils contained in two separate compartments of a capsule C3, that is, for example, coffee via path V1 and milk via path V2.

For this purpose, and as will be explained below, each capsule Ci of a particular type is able to have in its end wall an outlet orifice (T1 or T2 in the case of a C1 or C2 capsule) or two or more outlet orifices (in this case two orifices T1 and T2 in the case of a C3 capsule) which, because of the obligatory angular positioning of the capsule Ci in the brewing chamber 2, are allocated selectively to the first flow path V1 and/or to the second flow path V2 to which they are then hydraulically connected.

The brewing chamber 2 takes the form of a cylindrical bowl of revolution coaxial with the axis 4 which is open axially toward the rear AR and is defined towards the rear by a transverse annular edge 54. This bowl-shaped body of the brewing chamber 2 is defined axially towards the front (AV) by a transverse end wall 56 bearing two hollow needles Aig1 and Aig2. The two needles are parallel and extend axially toward the rear inside the brewing chamber 2.

The two needles are aligned with a vertical diameter of the chamber, the first needle Aig1 being beneath the second needle Aig2.

The first needle Aig1 is connected to a first external pipe 10 to form the first hydraulic path V1, while the second needle Aig2 is connected to a second external pipe 11 to form the second hydraulic path, separate from V1, connected to the interior of the brewing chamber 2.

Between the two needles, the end wall 56 of the brewing chamber 2, there is a spring-loaded ejector 32 which is a helical spring working in compression and able to bend elastically in the direction parallel to the axis of translation 4 and forwards in order to be compressed and to store the elastic energy when a capsule Ci is in place in the brewing chamber 2.

The spring-loaded ejector 32 has, when at rest and measured in the longitudinal direction, a length which is chosen to ensure axial ejection of the capsule from the chamber 2 after use.

The main features common to all capsules Ci, that is whatever their type, will now be described in detail.

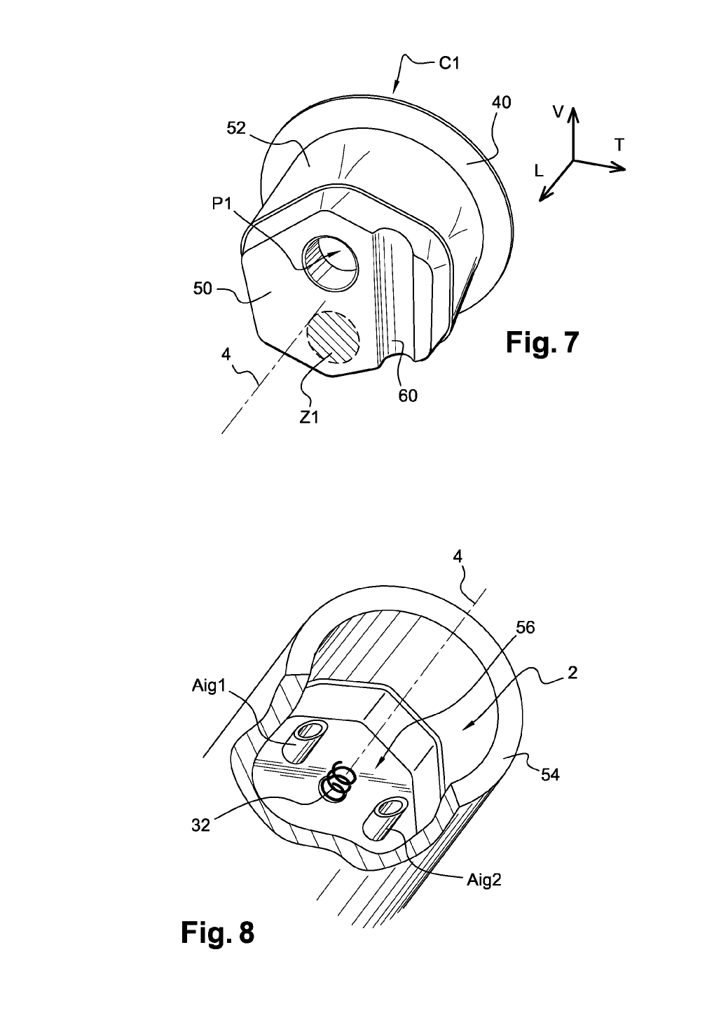

As can be seen in FIG. 7, each capsule Ci is a prismatic frustum of a cone in general shape. It may be made for example as a plastic molding and is bounded by a side wall 52 and, axially at the front, by a transverse end wall 50 which in this case is of hexagonal outline.

The side wall 52 is bounded axially to the rear by an annular edge 40 that extends radially outward in a transverse plane. The open rear face of the capsule through which it is initially filled with an essence to be brewed, in for example powder form, is closed by a film 51 which forms the rear transverse wall of the capsule through which the brewing water can be introduced into the capsule Ci.

The end wall 50 comprises a U-section groove 60 running parallel to a diameter and shifted sideways relative to the central axis 4′ of the capsule. The groove 60 serves as the polarizing cavity to force the unambiguous required position of the capsule in the brewing unit, and hence in the brewing chamber 2.

More specifically, the capsule shown in FIG. 7 and FIG. 10A is a capsule C1 of the first type in which the forward end wall 50 comprises, lined up vertically approximately on a “diameter”, a solid lower portion or zone Z1 of the wall which, when the capsule is in place in the brewing chamber 2, can be pierced by the needle Aig1 to create an orifice or hole T1 for the drink to flow out of the capsule C1.

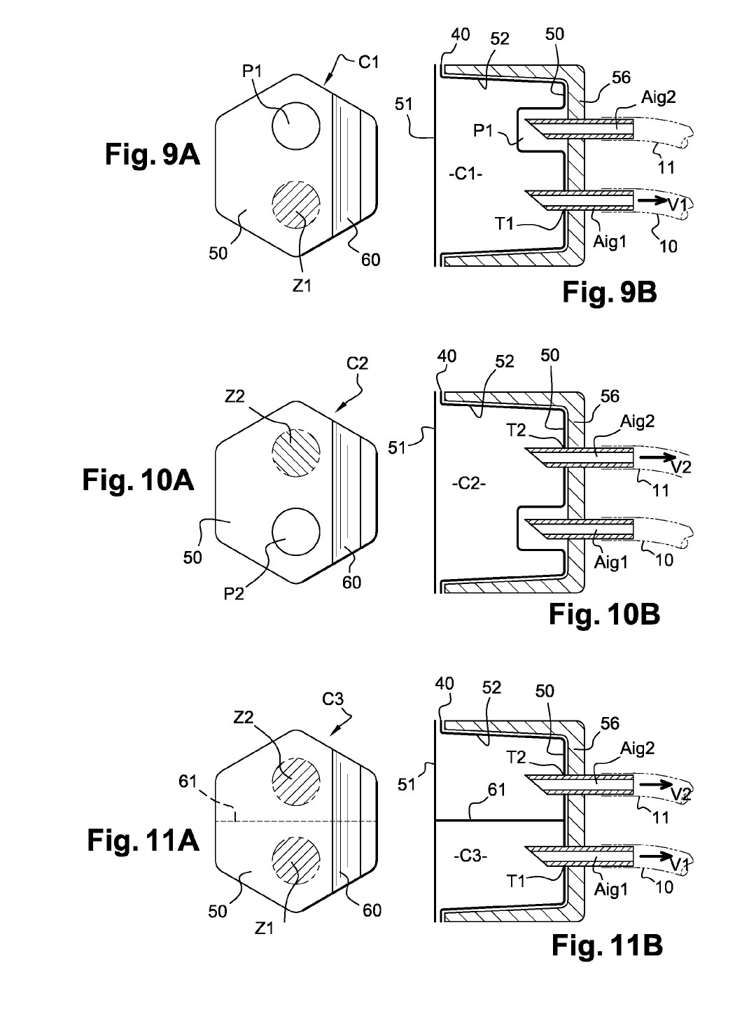

At the “top”, above the portion Z1, the forward end wall 50 comprises a portion P1, molded with the wall 50, which is in the form of a well extending axially toward the rear within the capsule to form a portion that cannot be perforated by the second needle Aig2 when the capsule C1 is in the brewing chamber (FIG. 9B).

Of course, the position and angular orientation of the capsule inside the chamber 2 are such that the needle Aig1 is lined up axially with the portion Z1 and the needle Aig2 is lined up axially with the well P1, within which it is received without perforating the capsule C1.

In the drink preparation position, as illustrated in FIG. 9B, it is hydraulic path V1 which is useful for emptying the drink from the brewing chamber 2 of the capsule C1.

The capsule shown schematically in FIG. 10A and FIG. 10B is a capsule C2 of the second type in which the forward end wall 50 comprises, lined up vertically approximately on a “diameter”, a solid upper portion or zone Z2 of the wall which, when the capsule is in place in the brewing chamber 2, can be pierced by the needle Aig2 to form an orifice or hole T2 through which the drink can flow out of the capsule C2.

At the “bottom”, below the portion Z2, the forward end wall 50 comprises a portion P2, molded with the wall 50, which is in the form of a well extending axially toward the rear inside the capsule C2 to form a portion that cannot be perforated by the first needle Aig1 when the capsule C2 is in the brewing chamber 2.

In the drink preparation position, as illustrated in FIG. 10B, it is the second hydraulic path V2 which is useful for emptying the drink from the brewing chamber 2.

The capsule shown schematically in FIG. 11A and FIG. 11B is a capsule C3 of the so-called third type in which the forward end wall 50 comprises, lined up vertically approximately on a “diameter”, a solid lower portion or zone Z1 of the wall which, when the capsule C3 is in place in the brewing chamber 2, can be pierced by the needle Aig1 to form a first orifice or hole T1 through which the drink can flow out of the capsule C3 along path V1, and—above the solid upper zone Z1—a solid upper zone Z2 of the wall which, when the capsule C3 is in place in the brewing chamber 2, can be pierced by the needle Aig2 to form a second orifice or hole T2 through which the drink can flow out of the capsule C3 along path V2.

In this way, the wall 50 of a capsule C3 can be pierced simultaneously by both needles Aig1 and Aig2 and both hydraulic paths V1 and V2 are used simultaneously for the outflow of the brewed liquid contained in the capsule C3. The capsule C3 may comprise (as illustrated in FIGS. 11A and 11B) a diametric axial internal partition 61 which makes it possible to brew two liquids of different compositions simultaneously, each of which flows out of the capsule via an associated hydraulic path.

The means of forced angular positioning of a capsule Ci, which are the same whatever type of capsule Ci is used, will now be detailed.

These means, also referred to as polarizing means, are in this case so-called male/female means which comprise the grooved cavity 60 of the capsule Ci present in the end wall of the latter, and the mating relief projection 18 formed in the housing 5 which surrounds the brewing unit.

The upper wall of the housing 5 comprises for this purpose a profiled opening 21 for the loading of a capsule Ci in a form such that the capsule Ci is in this case loaded vertically by inserting it in a downward direction, such that there is only one possible orientation for the cartridge relative to the housing 5, and therefore relative to the pressure plate 3 and to the chamber 2, in such a way that the inserted cartridge can only be inserted in one position and with one orientation.

Consequently, whatever type of cartridge Ci is used, the user, without having to think about the type of cartridge, places a cartridge Ci vertically and correctly in the opening 21, and in the chamber 2 (as will be understood later), because of the mating shaping of the loading opening 21 with its vertical projection 9 on the one hand, and the capsule Ci* on the other.

The rotation control means 7 comprise a main control lever 19, also called the actuating or driving lever of the closing pressure plate 3, for sliding the pressure plate 3 axially in both directions with respect to the housing 5 and with respect to the fixed brewing chamber 2.

Toward its rear longitudinal end, the control lever 19 is pivoted on the housing 5 about a horizontal transverse pivot pin 20.

The first pivot pin 20 is thus perpendicular to the axis of translation 4 of the pressure plate 3 with respect to the brewing chamber 2.

The axis of translation 4 and the first pivot pin 20 are both horizontal, but the pivot pin 20 is in this case offset vertically downward with respect to the axis of translation 4 (see FIG. 1).

In the embodiment described, the fixed brewing chamber 2 is fitted onto the housing and is fixed to the forward longitudinal end of the housing 5 by means of a transverse fixing rod 23 which runs through two opposite portions of the vertical side walls of the housing 5 and runs through two corresponding portions of the body of the brewing chamber.

The movable closing pressure plate 3 is connected rigidly to a horizontal transverse drive rod 24 whose opposite ends are guided in axial (longitudinal) translational movement in both directions of movement of the pressure plate, by two opposing parallel slots 25 in the housing 5 running longitudinally in the opposing vertical side walls of the housing 5, parallel to the axis of translation 4.

For this purpose, each end of the rod 24 is accommodated in a guide shoe 80 connected to the pressure plate and extending on the outside along the body of the pressure plate 3.

In response to the action of the control lever 19 which is hinged, toward its rear longitudinal end, to the housing 5, the closing pressure plate 3 is able to move longitudinally within and relative to the housing 5 toward and away from the brewing chamber 2, in such a way that it moves and positions itself with respect to the loading opening 21.

The closing pressure plate 3 is thus able to occupy a rear axial or “open” position in which it is situated axially to the rear of the loading opening 21 to allow a new capsule Ci to be inserted, and a forward axial position in which it hermetically seals the brewing chamber 2.

The dimensions and positions of the various components is thus such that the loading opening 21 is situated axially between the rear open position of the pressure plate 3 and the fixed brewing chamber 2.

The kinematic means 8 which convert the pivoting of the lever 19 in both directions relative to the housing 5, into an axial sliding movement of the pressure plate 3 along the axis 4 comprise in this case at least one pair of parallel links 26 between the lever 19 and the closing pressure plate 3.

The rear longitudinal end of each link 26 is connected and pivoted to the control lever 19 by a second pivot pin 27 which is parallel to the first pivot pin 20.

The forward longitudinal end of each link 26 is connected and pivoted to the rod 24 which thus also acts as a third pivot pin 28 between the links 26 and the movable (relative to the housing 5) part which is the pressure plate 3.

The second 27 and third 28 pivot pins are parallel to the first pivot pin 20, and therefore are horizontal and perpendicular to the axis of translation 4.

The closing pressure plate 3 comprises “gripping” means 35 for gripping the capsule Ci, comprising, at the opposite ends of the diameter of the closing pressure plate 3, two spring-action arms 36 extending parallel to the axis of translation 4. These gripping means are able to move axially in both directions with the pressure plate 3 and with respect to the housing 5 and therefore with respect to the brewing chamber 2.

A rear end of each arm 36 is fixed to the closing pressure plate 3, while a forward end, remote from the head of the closing pressure plate 3, comprises a gripping jaw 37 for retaining the rear peripheral edge 40 of the capsule Ci.

Each jaw 37 has a seat or well 45 divided by opposite parallel side walls 38 which are separated by a distance corresponding approximately to the thickness of the edge 40 of the capsule Ci which it is to accommodate, and by a curvilinear end wall 39 for intercepting a capsule Ci when it is inserted in free fall into the loading opening 21.

Each jaw 37 also has an inclined plane 48 for the further release of an initially retained capsule Ci.

The brewing chamber 2 has externally, on the path of the inclined plane 48 of each jaw 37, an inclined “meeting” plane 46 with the same slope as the slope of the plane 48.

The control lever 19 has a first rotation stop corresponding to the open position and a second rotation stop corresponding to the closed position of the brewing chamber 2.

The rotation stops (not shown) may take the form of for example appropriate projections on the casing of the housing 5.

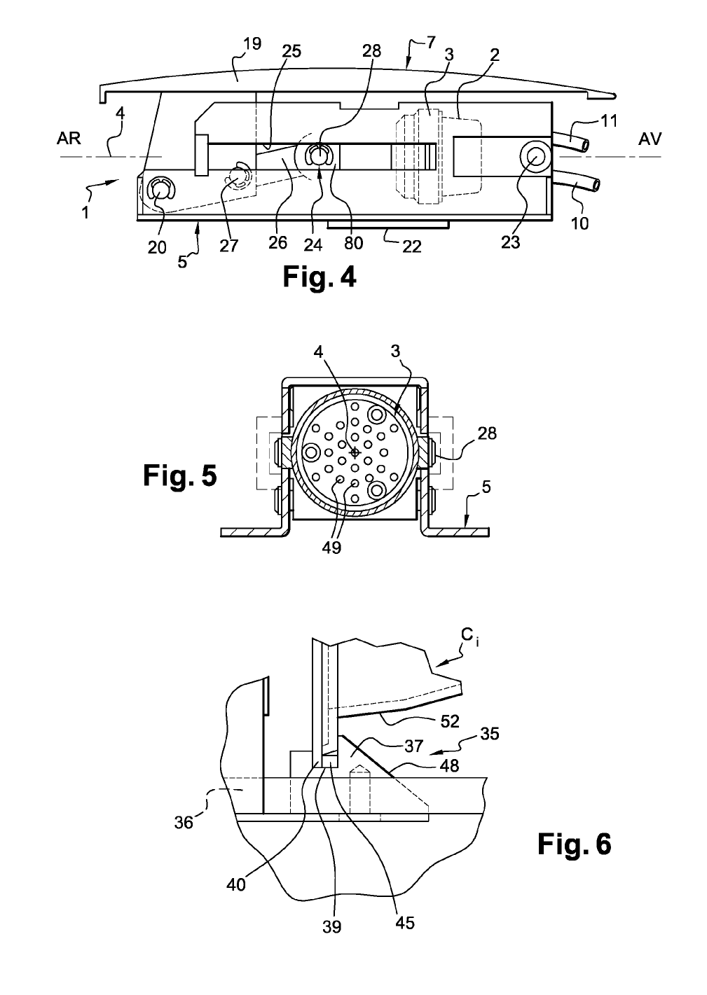

The control lever 19 is preferably continued lengthwise by a plate whose axial length is not less than the length of the housing 5 (see FIG. 4) and which, in a position corresponding to its closure, then extends above the loading opening 21, which is thus completely covered to ensure that, in this configuration of the brewing unit, it is not possible to load a new capsule Ci.

In particular, the size and/or shape and/or weight of the control lever 19 can be precisely decided so that, in its closed position, an additional locking moment is applied to the control lever 19 to ensure secure closure of the brewing chamber 2 by the closing pressure plate 3.

The method of actuating the brewing unit comprises manual pivoting of the control lever 19, and the conversion of this pivoting of the control lever 19 into a translational movement of the pressure plate 3, with its arms 36 between a rear open position and a forward sealed position of the brewing chamber 2.

In particular, when the control lever 19 is in the open position, a capsule Ci can be loaded, with the correct orientation, through the loading opening 21.

The capsule Ci drops down freely until its edge 40 is intercepted by the curvilinear end walls 39 of the wells 45 into which the capsule Ci is inserted vertically.

The opposite side walls 38 of the wells 45 guide and move the capsule Ci during the following axial translational movement of the closing pressure plate 3 which is brought about by the pivoting of the control lever 19.

The closing stroke of the closing pressure plate 3 comprises a first or advancing movement in which the closing pressure plate 3 passes into the brewing chamber until it reaches the end of the advancing movement, and a second or retreating movement in which the closing pressure plate retreats slightly from the end of the advancing movement, at the end of which movement the control lever is intercepted by the second rotation stop.

The amplitude of the angle formed by the first, second and third pivot pins 20, 27 and 28 in the plane perpendicular to these, varies between the open and closed positions of the brewing chamber 2.

In this embodiment, the pressure created during use inside the brewing chamber produces on the closing pressure plate 3 a force which, once transmitted to the control lever 19, is absorbed by the second rotation stop, and which can therefore produce no further pivoting of the control lever 19 in the direction in which the brewing chamber 2 opens.

Instead, in order to open the brewing chamber 2, a force must be applied to the closing pressure plate 3 in the opposite direction to that exerted by the internal pressure of the brewing chamber 2.

At the end of the closing stroke of the closing pressure plate 3, the meeting plane 46 bears axially on the inclined plane 48, to which it transmits a force that has a radial component relative to the axis of translation 4, outwards such that the two jaws move away from each other. This brings about a radial elastic deformation of the arms 36 that enables the edge 40 of the capsule Ci to be disengaged from the well 45 of the jaws 37.

Simultaneously, the ejector 32 is compressed by the compressive force exerted on it by the capsule Ci and applied to the capsule by the closing pressure plate 3.

Simultaneously, the points 49 with which the front face of the closing pressure plate 3 is provided, perforate the cover 51 of the capsule Ci to open an access path for the hot water into this capsule Ci.

When brewing is complete, when the control lever is rotated to bring about opening, the closing pressure plate 3 retreats without the capsule Ci which has first been released as will be described below.

Simultaneously, the ejector 32 relaxes, when the compressive force is removed, and pushes the capsule Ci far from the brewing chamber 2, expelling it toward the lower opening 22 through which the capsule is ejected from the housing 5.

The brewing unit of the present invention is thus able to ensure a precise, safe and reliable closure and a suitable hydraulic strength including when operating under pressure, as well as high flexibility of production and a quality of the resulting product, owing to the arrangement of multiple flow paths out of the brewing chamber which are employed selectively depending on the type of capsule used; and thus the product is obtained in a manner such as to avoid contamination of one product with the residues of a product of a different kind.

The appliance for brewing an aromatic drink with this design is susceptible of numerous modifications and alterations within the scope of the present invention.

All the components can of course be replaced by technically equivalent elements.

In practice, the materials used, and the dimensions, may be modified to suit requirements and to suit the prior art.

1. An assembly comprising an appliance (1) for brewing an aromatic drink using a disposable capsule (Ci) containing at least one aromatic essence to be brewed and having at least one disposable capsule (Ci), at least a portion of which is suitable for having at least one orifice (T1, T2) for the exit of the drink from the capsule, the appliance (1) being of the type that comprises:
a brewing unit formed partly of a brewing chamber (2) suitable for accommodating a capsule and partly of a pressure plate (3) for closing the brewing chamber, this pressure plate (3) being movable axially (4) between an open rear axial position (AR) allowing in particular a new capsule (C1, C2, C3) to be placed in the appliance and a closed forward axial position (AV) in which it closes the chamber (2) containing the new capsule, this pressure plate (3) being suitable for moving the capsule axially forward relative to the brewing chamber (2) in its axial travel in which it closes the brewing chamber (2);
polarizing means (21, 9, 60) for the forced unambiguous positioning of the capsule (Ci) in the brewing position within the brewing chamber (2);
a first hydraulic drink outflow path (V1) suitable to be connected to a first orifice (T1) of the capsule (C1, C3), through the brewing chamber; and
a second hydraulic drink outflow path (V2), hydraulically separate from the first hydraulic path (V1), which is suitable to be connected to a second orifice (T2) of the capsule (C2, C3), through the brewing chamber.

2. The assembly as claimed in claim 1, characterized in that:
the brewing chamber (2) comprises a first hollow needle (Aig1) that belongs to the first hydraulic outflow path (V1) and whose free end is suitable for perforating said portion (Z1) of a new capsule (C1, C3) so as to make in it a first orifice (T1) for the exit of the drink from the capsule (C1, C3) when this capsule is moved by the closing pressure plate (3) axially forward with respect to the brewing chamber (2);
the brewing chamber (2) comprises a second hollow needle (Aig2) that belongs to the second hydraulic outflow path (V2) and whose free end is suitable for perforating said portion (Z2) of a new capsule (C2, C3) so as to make in it a first orifice (T2) for the exit of the drink from the capsule (C2, C3) when this capsule is moved by the closing pressure plate (3) axially forward with respect to the brewing chamber (2);
and in that said capsule comprises a first wall portion (Z1) that extends adjacent to the free end of the first hollow needle (Aig1) and that is suitable to be perforated by the free end of this first hollow needle (Aig1), in such a way as to establish a first outflow route for the drink from the capsule (C1, C3) via said first hydraulic outflow path (V1), and/or comprises a second wall portion (Z2) that extends adjacent to the free end of said second hollow needle (Aig2) and that is suitable to be perforated by the free end of the second hollow needle (Aig2), in such a way as to establish a second outflow route for the drink from the capsule (C2, C3) via the second hydraulic outflow path (V2).

3. The assembly as claimed in claim 2, characterized in that said capsule (C1) comprises a wall portion (P1) that extends adjacent to the free end of the second (Aig2) of said two hollow needles (Aig1, Aig2) and that is suitable not to be perforated by the free end of this second hollow needle in such a way as to not establish an outflow route for the drink from the capsule via the second hydraulic outflow path (V2) to which said second hollow needle (Aig2) belongs, or in that said capsule (C2) comprises at least one wall portion (P2) that extends adjacent to the free end of the first (Aig1) of said two hollow needles (Aig1, Aig2) and that is suitable not to be perforated by the free end of this first hollow needle in such a way as not to establish an outflow route for the drink from the capsule via the first hydraulic outflow path (V1) to which said first hollow needle (Aig1) belongs.

4. The assembly as claimed in claim 2, characterized in that the first hollow needle (Aig1) and the second hollow needle (Aig2) extend axially rearward inside the brewing chamber, in that the capsule (C1, C2, C3) comprises a front transverse end wall (50), and in that each said wall portion (Z1, Z2) suitable to be perforated is a portion of said transverse end wall (50).

5. The assembly as claimed in claim 4, characterized in that each said wall portion (P1, P2) suitable not to be perforated is a portion of said transverse end wall (50) that is shaped as a well extending axially rearward into the capsule (C1, C2, C3).

6. The assembly as claimed in claim 2, characterized in that the closing pressure plate (3) has means (36, 37) for gripping a capsule (Ci) in such a way as to hold the capsule in said unambiguous position relative to the pressure plate (3), and move the capsule (Ci) axially forward during the axial travel of the pressure plate (3) in which it closes the chamber (2).

7. The assembly as claimed in claim 6, characterized in that, in the forward axial position of closure of the brewing chamber, the pressure plate (3) encloses a capsule (C1, C2, C3) inside the brewing chamber (2), and in that at least one of said portions (Z1, Z2) suitable to be perforated is perforated by an associated hollow needle (Aig1, Aig2).

8. The assembly as claimed in claim 4, characterized in that the capsule (Ci) is in the general form of a frustum of a cone and is defined axially at the front by said transverse end wall (50) and at the rear by a forward transverse wall (51) that forms a face whereby the brewing liquid is introduced into the capsule (Ci), and in that the axis of the frustoconical capsule is parallel to the axis (4) of movement of the pressure plate (3) when the capsule is in the brewing position in the brewing chamber (2).

9. The brewing assembly as claimed in claim 1, characterized in that it comprises pivoting means (19) for controlling the brewing unit, and kinematic conversion means (26) suitable for converting a pivoting of said control means into a relative movement of the pressure plate (3) with respect to the chamber (2) along said axis of translation (4).

10. The brewing assembly as claimed in claim 1, characterized in that said positioning means are male/female engagement means (21, 9 and 60) comprising a cavity (60) in the capsule (Ci) whose shape mates that of a relief projection (9).

11. The assembly as claimed in claim 10, characterized in that:
the brewing chamber (2) comprises a first hollow needle (Aig1) that belongs to the first hydraulic outflow path (V1) and whose free end is suitable for perforating said portion (Z1) of a new capsule (C1, C3) so as to make in it a first orifice (T1) for the exit of the drink from the capsule (C1, C3) when this capsule is moved by the closing pressure plate (3) axially forward with respect to the brewing chamber (2);
the brewing chamber (2) comprises a second hollow needle (Aig2) that belongs to the second hydraulic outflow path (V2) and whose free end is suitable for perforating said portion (Z2) of a new capsule (C2, C3) so as to make in it a first orifice (T2) for the exit of the drink from the capsule (C2, C3) when this capsule is moved by the closing pressure plate (3) axially forward with respect to the brewing chamber (2);
the capsule the comprises a first wall portion (Z1) that extends adjacent to the free end of the first hollow needle (Aig1) and is suitable to be perforated by the free end of this first hollow needle (Aig1), in such a way as to establish a first outflow route for the drink from the capsule (C1, C3) via said first hydraulic outflow path (V1), and/or comprises a second wall portion (Z2) that extends adjacent to the free end of said second hollow needle (Aig2) and is suitable to be perforated by the free end of the second hollow needle (Aig2), in such a way as to establish a second outflow route for the drink from the capsule (C2, C3) via the second hydraulic outflow path (V2); the first hollow needle (Aig1) and the second hollow needle (Aig2) extend axially rearward inside the brewing chamber; the capsule (C1, C2, C3) comprises a front transverse end wall (50), and each said wall portion (Z1, Z2) suitable to be perforated is a portion of said transverse end wall (50); and
said cavity (60) is formed in said end wall (50) of the capsule.

12. The brewing assembly as claimed in claim 10, characterized in that it comprises a housing (5) that houses the brewing unit, and in that the housing comprises an upper opening (21) for the loading of a capsule and a lower opening (22) for the removal of said capsule.

13. The brewing assembly as claimed in claim 1, characterized in that said closing pressure plate (3) has capsule gripping means.

14. The brewing assembly as claimed in claim 13, characterized in that said gripping means comprise, at two opposite ends of a horizontal diameter of the closing pressure plate, two spring-action arms (36) that extend parallel to said axis of translation (4).

15. The brewing assembly as claimed in claim 14, characterized in that the forward end of each arm comprises a retaining jaw (37) for gripping a rear edge of a capsule.

16. The brewing assembly as claimed in claim 15, characterized in that each jaw (37) comprises an inclined plane for releasing the locking of said capsule, and in that said brewing chamber has, on the path of said inclined plane, a corresponding meeting plane with the same slope.

17. A capsule suitable to be accommodated in an appliance of an assembly as claimed in claim 1, characterized in that its body is a plastic molding.

18. The assembly as claimed in claim 3, characterized in that the first hollow needle (Aig1) and the second hollow needle (Aig2) extend axially rearward inside the brewing chamber, in that the capsule (C1, C2, C3) comprises a front transverse end wall (50), and in that each said wall portion (Z1, Z2) suitable to be perforated is a portion of said transverse end wall (50).

19. The assembly as claimed in claim 1, characterized in that the closing pressure plate (3) has means (36, 37) for gripping a capsule (Ci) in such a way as to hold the capsule in said unambiguous position relative to the pressure plate (3), and move the capsule (Ci) axially forward during the axial travel of the pressure plate (3) in which it closes the chamber (2).

20. The assembly as claimed in claim 3, characterized in that the closing pressure plate (3) has means (36, 37) for gripping a capsule (Ci) in such a way as to hold the capsule in said unambiguous position relative to the pressure plate (3), and move the capsule (Ci) axially forward during the axial travel of the pressure plate (3) in which it closes the chamber (2).
